(19) United States
(12) Patent Application Publication
(10) Pub. No.: US 2017/0154291 A1
(43) Pub. Date: Jun. 1, 2017

(54) VISUALIZATION OF KEY PERFORMANCE INDICATOR DEPENDENCIES

(71) Applicant: SAP SE, Walldorf (DE)

(72) Inventors: Frithjof DAU, Dresden (DE); Amit Kumar SINGH, Varanarasi (IN); Shailesh BORKAR, Gondia (IN); Nachiket VINAYA, Gondia (IN); Vidur Shailendra BHATNAGAR, Roorkee (IN)

(21) Appl. No.: 14/954,139

(22) Filed: Nov. 30, 2015

(51) Int. Cl. G06Q 10/06

(52) U.S. Cl. CPC G06Q 10/06393

(57) ABSTRACT

A computer-implemented method includes receiving, by a rendering engine, a set of key performance indicators (KPIs) and KPI drivers characterizing a business process. The method involves using the rendering engine to establish a concept hierarchy for the KPIs and KPI drivers in the set of KPIs and KPI drivers. The method further includes creating, by the rendering engine, a directed acyclic graph (DAG) of the set of KPIs and KPI drivers based on the established concept hierarchy, and rendering a visual representation of the directed acyclic graph as a KPI node-link diagram on a computer-user interface.

### BACKGROUND

A key performance indicator (KPI) is a business metric of a business process model of an organization. KPIs may be used to evaluate factors that are crucial to the success of the business process (and the organization). KPIs may differ from organization to organization. For example, a business KPI may be a net revenue or a customer loyalty metric, while a government KPI may be unemployment rates.

Organizations use a large number of KPIs at multiple levels of the business process to evaluate success in reaching targets. High-level KPIs may focus on the overall performance of the organization, while low-level KPIs may focus on processes in departments such as sales, marketing and finance. KPIs for Sales may, for example, include KPIs such as: Sales Growth, Sales Opportunities, Sales Opportunities, Product Performance, Average Profit Margin, Monthly Recurring Revenue (MRR) Expansion Rate, Monthly Recurring Revenue (MRR), Customer Churn Rate, Customer Retention Rate, Sales Target, Average Purchase Value, Sales by Contact Method, Sales Bookings, Quote To Close Ratio, Sales Per Rep, etc. KPIs for marketing may, for example, include KPIs to gauge the market and marketing efforts such as: Market Growth Rate, Market Share, Brand Equity, Cost per Lead, Conversion Rate, Search Engine Rankings (by keyword) and click-through rate, Page Views and Bounce Rate, Customer Online Engagement Level, Online Share of Voice (OSOV), Social Networking Footprint, and K1 out Score, etc. KPIs for Finance may, for example, include KPIs to measure financial performance such as: Net Profit. Net Profit Margin, Gross Profit Margin, Operating Profit Margin, EBITDA, Revenue Growth Rate, Total Shareholder Return (TSR), Economic Value Added (EVA), Return on Investment (ROI), Return on Capital Employed (ROCE), Return on Assets (ROA), Return on Equity (ROE), Debt-to-Equity (D/E) Ratio, Cash Conversion Cycle (CCC), Working Capital Ratio, and Operating Expense Ratio (OER), CAPEX to Sales Ratio, Price Earnings Ratio (P/E Ratio), etc.

Another type of performance metric is a key performance driver (KPD), which may be a leading indicator or early warning that a situation exists that if not addressed will lead to a poor KPI result. For example, customer satisfaction may be a leading indicator of a customer retention KPI. Each KPI may include one or more measureable components or depend on one or more measureable performance drivers. A performance metric may be associated with a preceding step in a value stream. For example, if the KPI is on-time-in-full shipments, then a performance driver may be manufacturing lead time, which impacts the flexibility of responding to customer orders. Alternatively, a performance metric may be a metric that contributes directly to a KPI and may be a component in the way the KPI is calculated. For example, a gross margin KPI could be calculated as sales units times list price less discounts less cost-of-good-sold, and hence each of these components contributes to and is a driver of gross margin.

An organization, which has a large or extensive business process, may use a large number of KPIs to monitor the business process. The large number of KPIs may include a large number of interrelated KPIs, components and drivers. Business applications or software can be used to calculate the interrelated KPIs, components and drivers. These business applications can generate tremendous amounts of numerical data (usually presented in tabular form in one or more spreadsheets) on the interrelated KPIs, components and drivers. It may be difficult for an analyst to peruse through the numerical data, which may be presented in tabular form, to understand the interplay between the various KPIs, components and drivers.

Consideration is now given to visualization techniques for presenting the interplay between the various KPIs, components and drivers.

### SUMMARY SECTION

In a general aspect, a computer system includes a memory, a semiconductor-based processor; and a rendering engine. The rendering engine is configured receive a set of key performance indicators (KPIs) and KPI drivers characterizing a business process and establish a concept hierarchy for the KPIs and KPI drivers in the set of KPIs and KPI drivers. Each concept in the concept hierarchy represents a set of KPI-driver matrix objects sharing one or more same attributes for a certain set of properties and each sub-concept in the concept hierarchy contains a subset of the objects in the concepts above the sub-concept in the concept hierarchy.

In a further aspect, the rendering engine is configured to create a directed acyclic graph (DAG) of the set of KPIs and KPI drivers based on the established concept hierarchy, and render a visual representation of the directed acyclic graph (DAG) as a KPI node-link diagram on a computer-user interface.

The details of one or more implementations are set forth in the accompanying drawings and the description below. Further features of the disclosed subject matter, its nature and various advantages will be more apparent from the accompanying drawings, the following detailed description, and the appended claims.

### BRIEF DESCRIPTION OF THE DRAWINGS

FIG. 1 is a schematic block diagram illustration of an example system, which includes a business application configured to monitor a business process and generate or compute KPI information (e.g., numerical values of the KPIs, KPI components and drivers) for a business process, and which includes a rendering engine configured to render a KPI node-link diagram based on the computed KPI information on a computer-user interface, in accordance with the principles of the present disclosure.

FIG. 2 is an illustration of an example KPI-dependency matrix, which may be processed by a business application, in accordance with principles of the present disclosure.

FIG. 3 is a schematic illustration of a right-headed drawing of a KPI node-link diagram, in accordance with the principles of the present disclosure.

FIG. 4 is an illustration of an example KPI node-link diagram, which may be rendered by a rendering engine on a computer screen to visually depict KPI interrelationships, in accordance with the principles of the present disclosure.

FIG. 5 is an illustration of another example KPI node-link diagram, which may be rendered by a rendering engine on a computer screen to visually depict KPI interrelationships, in accordance with the principles of the present disclosure.

FIG. 6 is an illustration of yet another example KPI node-link diagram, which may be rendered by a rendering engine on a computer screen to visually depict KPI interrelationships, in accordance with the principles of the present disclosure.

FIG. 7 is an illustration of an example KPI node-link diagram in which a rendering engine displays numerical values of the displayed drivers and KPIs, in accordance with the principles of the present disclosure.

FIG. 8 is an illustration of an example KPI node-link diagram in which a rendering engine highlights a chain of driver-KPI dependencies across several levels of hierarchy levels, in accordance with the principles of the present disclosure.

FIG. 9 is an illustration of an example method using a rendering engine to visualize a set of KPIs and KPI drivers on a computer-user interface, in accordance with the principles of the present disclosure.

### DETAILED DESCRIPTION

A business process modeling application (“business application”) is used to monitor and characterize various business processes that may occur in an organization, business, or industry. The business processes may be characterized by any number of key performance indicators (KPIs). The business application, which may be hosted on a computer network, may monitor the business processes and may generate or compute numerical values of the KPIs, KPI components and drivers for the business processes. A KPI may be interrelated with other KPIs i.e. a KPI may depend on another KPI. The business application may output the computed values of the KPIs, KPI components and drivers, for example, in tabular format in one or more tables or spread sheets.

A KPI visualization module or rendering engine, which may be coupled to the business application, is configured to compute a directed acyclic graph (DAG) of the interrelationships of the KPIs and display the DAG visually as a KPI node-link-diagram on a computer user interface (UI), in accordance with the principles of the present disclosure.

The DAG or KPI node-link-diagram may visually bring forth the interrelationships and the dependencies between KPIs, components and drivers. The KPI node-link diagram may visually demonstrate which drivers influence a given KPI and which drivers influence more than one KPI. The KPI node-link diagram may also visually demonstrate which KPIs are influenced more by drivers than by other KPIs.

The KPIs and associated drivers of the business processes may be represented by one or more KPI-driver matrices. The KPI node-link-diagram may be a visual representation of a KPI-driver matrix a business process. In example visualization implementations, a concept hierarchy or formal ontology may be established for the KPI-driver matrix (using, for example, Formal Concept Analysis (FCA)). Each concept in the hierarchy may represent a set of KPI-driver matrix objects sharing the same values for a certain set of properties; and each sub-concept in the hierarchy may contain a subset of the objects in the concepts above it in the hierarchy. The KPI node-link-diagram may visually represent the concept hierarchy of the KPI-driver matrix in form of a diagram.

The KPI node-link-diagram may be presented as an interactive graphical representation of business process, which may be dynamic, on the computer user interface. A viewer may, for example, focus on, explore, investigate, monitor, intervene, or study individual KPIs at different levels detail on the computer user interface. A unified or overall view of KPIs characterizing the business process at one or more levels of detail may beneficially provide perspective and contextual information to the viewer.

Systems and methods for presenting the KPI node-link-diagram for the business process on a computer screen are described herein, in accordance with the principles of the present disclosure.

Visual user interface control elements (“visual UI elements”) may be integrated in the KPI node-link-diagram displayed on the computer screen. The visual UI elements may be configured so that a user can interact with the displayed KPI node-link-diagram to focus on, explore, investigate, monitor, or study individual KPIs at different levels of the concept hierarchy displayed of the computer screen.

The KPI visualization module or rendering engine may be programmed or coded to establish the concept hierarchy for the KPI-driver matrix (using, for example, Formal Concept Analysis (FCA)) and to display a corresponding KPI node-link-diagram, for example, on an interactive frontend interface of the business application.

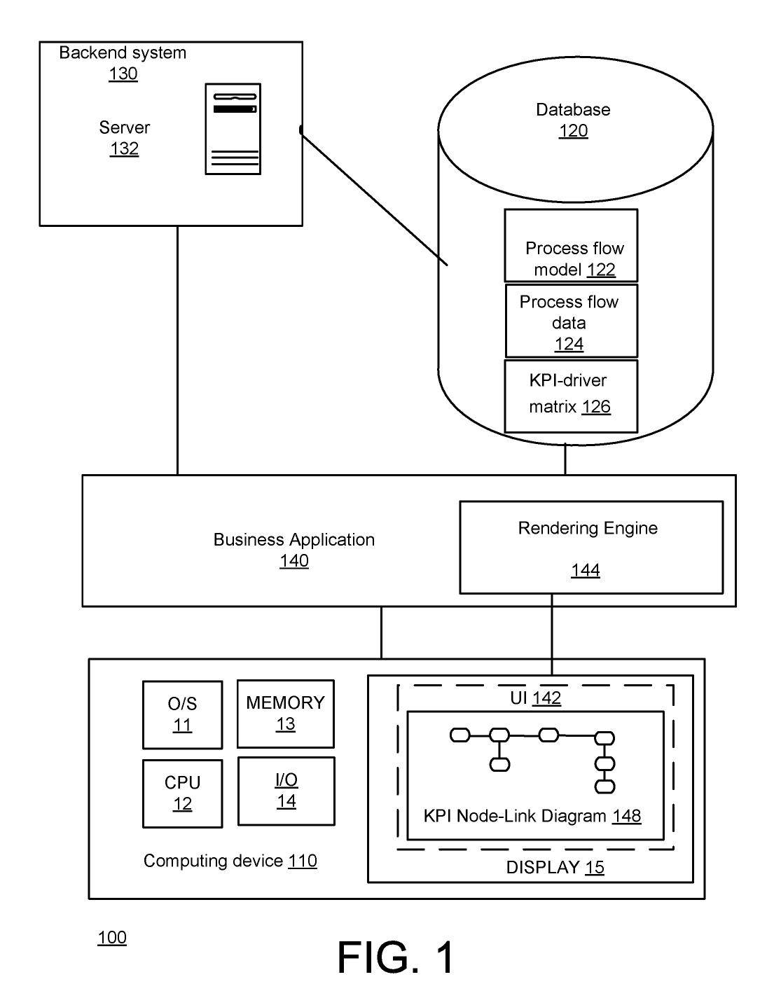

FIG. 1 is a schematic block diagram showing an example system 100 including a business process modeling or monitoring application (e.g., business application 140), which is configured to monitor a business process and generate or compute KPI information (e.g., numerical values of the KPIs, KPI components and drivers) for the business process. System 100 may include a rendering engine 144 configured to render a KPI node-link diagram (e.g., KPI node-link diagram 148) based on the computed KPI information on a computer-user interface, in accordance with the principles of the present disclosure.

In system 100, business application 140 may be coupled to one or more databases (e.g., a business database 120). Business database 120 may, for example, include data defining a process model (e.g., process flow model 122) of the business process. Business database 120 may further include, or dynamically accumulate process flow information (e.g., process flow data 124) related to various process steps in the business process. Business application 140 may use process flow data 124 to compute the KPI information (e.g., values of the KPIs, KPI components and drivers) for the business process. The computed KPI information may, for example, include a KPI-driver matrix 126 (e.g., stored in database 120).

In an illustrative example implementation of system 100, business application 140 may, for example, be hosted or launched on a computer 110. Computer 110, which includes an 0/S 11, a CPU 12, a memory 13, and I/O 14, may further include a user interface or display screen (e.g., display 15). Although computer 110 is illustrated in the example of FIG. 1 as a single computer, it may be understood that computer 110 may represent two or more computers in communication with one another. Therefore, it will also be appreciated that any two or more components 120-148 of system 100 may similarly be executed using some or all of the two or more computers in communication with one another. Conversely, it also may be appreciated that various components illustrated as being external to computer 110 may actually be implemented therewith. In an example scenario, business application 140 may be an application, which can run on computer 110 or, for example, in another computing environment (e.g., backend system 130/server 132).

Rendering engine 144 (which may be included or coupled to business application 140) may configured to render KPI node-link diagram 148) on an interactive frontend (e.g., UI 142) of the business application. UI 142 may, for example, be constructed using standard components (e.g., generic user interface building blocks (UIBBs)) and/or custom-developed components for UI display entities (e.g., graphics, charts, lists, forms, trees, etc.), which can be used to display data. The information displayed on UI 142 by the rendering engine 144 may, for example, include details of, or other information (e.g., name, numerical value, etc.) associated with, specific nodes or hierarchy levels of KPI node-link diagram 148. Such information (e.g., names, numerical values, etc.) may be displayed, for example, in text format.

Rendering engine 144 may include processes for establishing a concept hierarchy or formal ontology for KPI-driver matrix 126 (using, for example, Formal Concept Analysis (FCA)) and rendering the established concept hierarchy as KPI node-link diagram 148 on UI 142. The following terminology may be used herein to describe the mathematical interrelationships between KPIs and drivers (e.g., in KPI-driver matrix 126) with regard to the concept hierarchy.

Terminology
For a KPI “K” and a driver “D” such that D is used in a computational formula for K, D is a driver for K or D influences K, and K depends on D.
A KPI “K1” is below another KPI “K2” if and only if the set of drivers for “K1” is a strict subset of the set of drivers for KPI K2. We write K1<K2;
If we have K1<K2, and there is no K3 with K1<K3<K2, we say that K1 is directly below K2.
K is between K1 and K2, if and only if K1<K<K2;
A KPI is minimal if there is no (other) KPI below it in the hierarchy;
A KPI “K3” is equivalent to another KPI “K4”, if and only if the set of drivers for K3 is identical to the set of drivers for KPI K4;
A KPI K is singular if and only if there is no other KPI which is equivalent to K. A set “K5” of KPIs is called an equivalence class if and only if all KPIs in K5 are equivalent, and K5 is maximal with this property (i.e. there is no other equivalent KPI outside K5). For a KPI K6, let Eqv(K6) denote the set of all KPIs which are equivalent to K6 (this set contains K6 as well); and
As equivalence classes contain equivalent KPIs, notions “below”, “between”, and “minimal” apply for the classes as well, KPIs and classes can be mixed (e.g. “a KPI is below an equivalence class”);

Further, additional terminology based on notions of clusters of drivers and clusters of KPIs may be used herein to describe the mathematical interrelationships between KPIs and drivers (e.g., in KPI-driver matrix 126) with regard to the concept hierarchy.

Additional Terminology
For a set “D” of drivers, let KPI(D) be the set of all KPIs which depend on all drivers of D. Similarly, for a set “K” of KPIs, let Drv(K) be the set of all drivers which influence all KPIs in K;
A pair (D, K), where D is a set of drivers, K is a set of KPIs, and where Drv(D)=K and Drv(K)=D, is called driver-KPI-concept;
For two driver-KPI-concepts (D1, K1) and (D2, K2), (D1, K1) is below (D2, K2), if and only if D1 is a strict subset of D2. (D1, K1)<(D2, K2);
If we have (D1, K1)<(D2, K2) and if there is no concept (D3, K3) with (D1, K1)<(D3, K3)<(D2, K2), we say (D1, K1) is directly below (D2, K2); and,
a driver-KPI-concept (D, K) is between two driver-KPI-concepts (D1, K1) and (D2, K2), if and only if (D1, K1)<(D, K)<(D2, K2).

Rendering engine 144 may, for example, use the foregoing terminology and ordering relationships to establish the concept hierarchy or formal ontology for KPI-driver matrix 126. Rendering engine 144 may further render the so-established concept hierarchy or formal ontology for KPI-driver matrix 126 as a directed acyclic graph (e.g., KPI node-link diagram 148) on UI 142.

Example Problem Scenario

For purposes of illustration, an example business process monitored by business application 140 may be monitored for financial planning and analysis purposes. For the example financial planning and analysis of the business process, financial analysts or other users may contend with different financial numbers and measures (e.g., “profit”, “revenue”, “costs”, etc.). Some of the measures may be numbers that can be directly entered or input in to business application 140. Conversely, some of the measures (which depend on other measures) may be computed or derived by business application 140 using formulas or equations. For planning purposes, it may be important that specific measures are monitored to be within specific, user-defined ranges (e.g., profit must be at least 1 million Euros). Such specific measures may be referred to hereon as Key Performance Indicators (KPIs), and the measures these KPIs depend on may be referred to as the drivers (of the respective KPIs). In common cases, measures that are KPIs are computed from other measures, but it may be possible that a KPI-measure can be directly entered (i.e. the KPI-measure is its own driver, or in other words—a measure can be a KPI and a driver simultaneously).

The example financial planning and analysis of the business process, may be characterized by the following example measures: meal cost per employee; employee count; rent cost; total HR IT cost; total other costs; total power cost; employee count; site surface; cost per employee, power cost per employee; power cost per sqm.;, total costs; profit; profit per employee; HR IT costs per employee; HR IT costs per T.; and revenue.

In the example financial planning and analysis of the business process, the following measures may be computed from other measures via formulas or equations (shown below) and considered to be KPIs:
cost per employee=(meal cost per employee*employee count+rent cost+total HR IT cost+total other costs+total power cost)/employee count;
power cost per employee=total power cost/employee count;
power cost per sqm.=total power cost/site surface;
total costs=meal cost per employee*employee count+rent cost+total HR IT cost+total other costs+total power cost;
profit=revenue−(meal cost per employee*employee count+rent cost+total HR IT cost+total other costs+total power cost);
profit per emp.=(revenue−(meal cost per employee*employee count+rent cost+total HR IT cost+total other costs+total power cost))/employee count;
HR IT costs per employee=total HR IT cost/employee count;
HR IT costs per Temp.=total HR IT cost/(employee count*1000); and revenue=revenue.

It will be noted from the foregoing that revenue is both a KPI and a driver. Further, it will be noted that the KPIs are not all independent but can share common drivers.

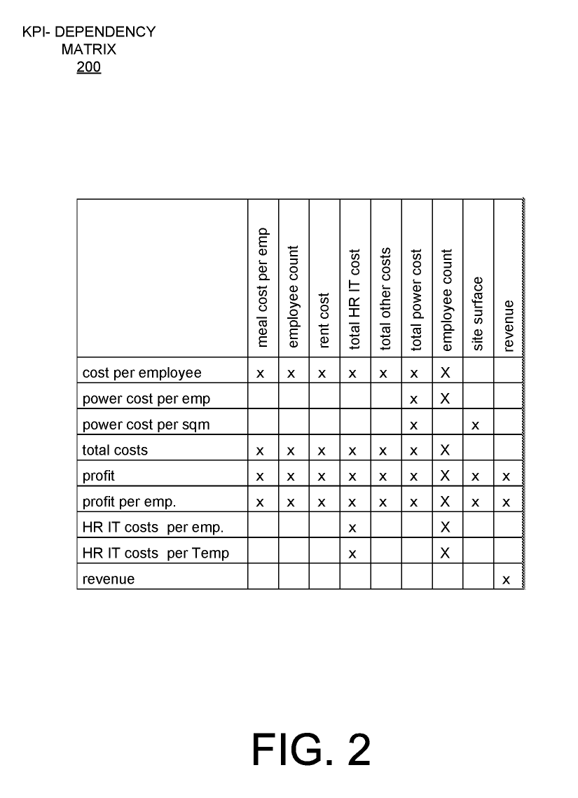

FIG. 2 shows an example KPI-dependency matrix 200, which may be processed by business application 140 in the foregoing example financial planning and analysis of the business process, in accordance with principles of the present disclosure.

The interrelationships of the KPIs and the drivers (shown, for example, in KPI-dependency matrix 200) may lead to a problem of unintentionally changing more than one KPI when a driver is purposefully changed to control or adjust one particular KPI in the business process monitored by business application 140. If, for example, in the business process monitored by business application 140, the KPI “power cost per employee” (which is computed as “total power cost/employee count) changes to a critical state (e.g., exceeds a threshold value), the financial analyst or other users attempting to control the business process may change one or more of the drivers of the KPI “power cost per employee” in order to bring the KPI “power cost per employee” into an uncritical state (e.g., less than the threshold value). For example, the financial analyst or other users may increase the driver—“employee count”, which would decrease the KPI. However, then, not only is the KPI—“power cost per employee” changed as a result, but all other KPIs (e.g., cost per employee, power cost per employee, total costs, profit, profit per employee, HR IT costs per employee, and HR IT costs per Temp.) that depend on the same driver—“employee count”, will be changed. Some of these KPIs (e.g., profit) may be negatively impacted by the increase in the driver—“employee count”. This example illustrates how when some drivers are changed to bring one KPI into an uncritical state, other KPIs of the business process may be inadvertently changed from uncritical states into critical states.

Rendering engine 144 of business application 140 may provide visualizations (e.g., KPI Node-Link Diagram 148) of the KPI—dependency interrelationships to help a viewer (e.g., the financial analyst or other users) to gain understanding of how the change in one KPI may cause changes in other interrelated KPIs. With this understanding, the viewer may be able to control the business process KPIs holistically by recognizing that a change to a single driver may affect a group or cluster of KPIs.

In the foregoing Example Problem Scenario, business application 140/rendering engine 144 may compute directed acyclic graphs (DAG) out of KPI-dependency matrix 200, and then provide visualizations of the KPI interrelationships in form of node-link-diagrams (e.g., KPI Node-Link Diagram 148) on UI 142.

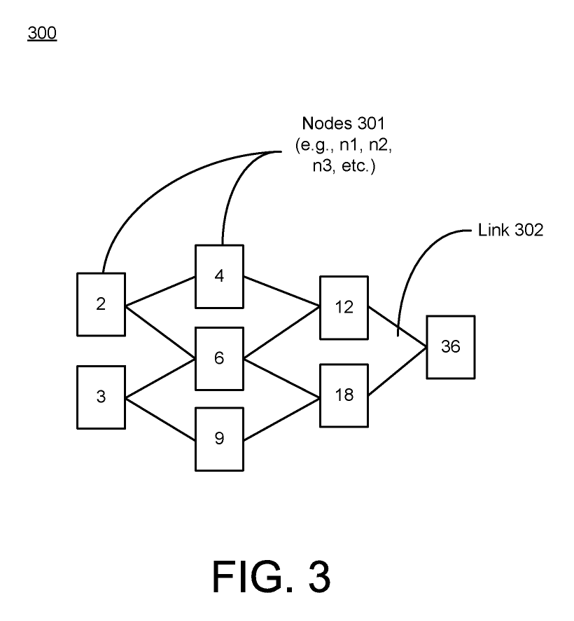

In example implementations, the KPI node-link diagram presented on UI 142 may be formatted as a right-headed drawing i.e. the visualization may be designed to be read from left to right. FIG. 3 shows an example of a right-headed drawing 300 of the KPI node-link diagram. In drawing 300, nodes 301 of the KPI node-link diagram are, for example, marked by numbers n1, n2, n3, etc. (e.g., 2, 3, 4, 6, 9, etc.) A link (e.g., link 302) between two nodes (e.g., node n1 and node n2) may be read or interpreted as meaning that node n2 is the twofold or threefold of node n1. When one can go from one node n1 to another node n2 by traversing drawing 300 rightwardly, then node n1 may be read or interpreted being a divider of node n2.

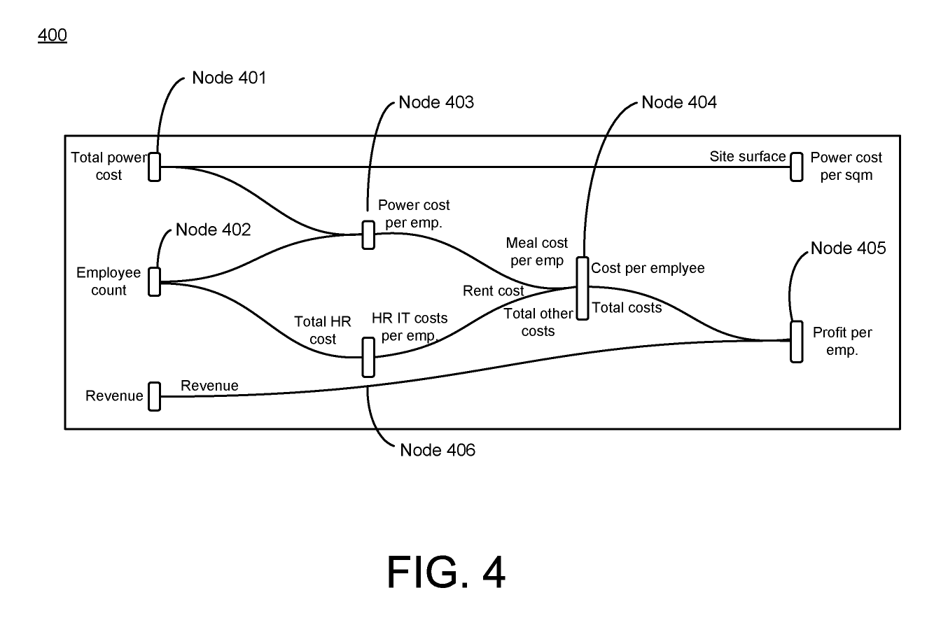

FIGS. 4, 5 and 6 show example KPI node-link diagrams 400, 500 and 600, respectively, which may be rendered by rendering engine 144 on UI 142 to visually depict the KPI interrelationship in the foregoing Example Problem Scenario.

With reference to FIG. 4, the nodes in KPI node-link diagram 400 may be represent concepts (e.g., driver-KPI-concepts) of the concept hierarchy for KPI-driver matrix 200). Rendering engine 144 may generate KPI node-link diagram 400 by establishing the concept hierarchy for KPI-driver matrix 200 and using notions of so-called object-concepts and attribute-concepts to order and link the nodes in KPI node-link diagram 400. Rendering engine 144 may generate a link between two concepts C1 and C2 if and only if C1 is below C2 and there is no other concept between C1 and C2.

Rendering engine 144 may use the following example algorithms for generating the driver-KPI concept nodes and generating the links that are shown in KPI node-link diagram 400.

Generation of Nodes:
For each driver D, generate the driver-KPI-concept node(D):=(Kpi(D), Drv(Kpi(D))); and,
For each KPI K, generate the driver-KPI-concept node(K):=(Kpi(Drv(K)), Drv(K)).

It may be noted that with this algorithm, different drivers or KPIs can be represented by a same node i.e. for different drivers D1 and D2 and different KPIs K1 and K2, we have node(D1)=node(D2), or node(K1)=node(K2), or node(D1)=node (K1) (“or” is meant to be non-exclusive, i.e. we can have even combinations of these equations).

Generation of Links:
For two nodes n1 and n2 such that n1 is directly below n2, a link from n1 to n2 is added.

Rendering engine 144 may generate a link between two concepts C1 and C2 if and only if C1 is directly below C2. KPI node-link diagram 400, which is shown in FIG. 4, may be generated by rendering engine 144 using the foregoing example algorithms for Generation of Nodes and Generation of Links. In FIG. 4, the nodes (e.g., nodes 401, node 402, etc.), which are depicted, for example, as rectangles, represent specific driver-KPI concepts, namely so-called object-concepts and attribute-concepts. The labels (e.g., meal cost per employee, rent cost and total cost) shown on the left of the nodes (e.g., node 404) may, for example, represent the drivers of the respective driver-KPI concepts, and the labels (e.g., cost per employee and total cost) shown on the right of the nodes (e.g., node 402) may, for example, represent the KPIs of the respective driver-KPI concepts.

KPI node-link diagram 400, as shown in FIG. 4, may, for example, visually convey the following information on the Equivalence of drivers and KPIs, the Dependencies between KPIs, and the Dependencies between drivers, to a viewer.

### Equivalence of Drivers and KPIs:

For example, KPIs “cost per employee” and KPI “total cost” depend on exactly the same drivers (as they are on the same node 404). Similarly, drivers “meal cost per employee”, “rent cost” and “total other cost” influence exactly the same KPIs.
   Dependencies between KPIs:
For example, The KPI “power cost per employee” (on node 403) depends on fewer drivers (e.g., total power cost and employee count on nodes 401 and 402, respectively) than the KPI “total cost” (on node 404), which in turn depends on less drivers than the KPI “profit” (on node 405).
   Dependencies between Drivers:
For example, Driver “Employee count' (on node 402) influences more KPIs than driver “total HR IT cost” (on node 406), which in turn influences more KPIs than the driver “meal cost per employee” (on node 404).

Rendering engine 144 may, for example, use the following example algorithms for generating the single driver or single KPI nodes and generating the links that are shown in KPI node-link diagram 500.

Generation of Nodes:
For each driver D, generate a fresh node—node(D);
For each KPI K generate a fresh node—node(K); and
For each equivalence class E containing more than one element and which is not minimal, generate a fresh node—node(E), called generic node.

Generation of Links:
For each driver D and each KPI K such that (Kpi(D), Drv(Kpi(D))) is directly below (Kpi(Drv(K)), Drv(K)), add a link from node(D) to node(K);
For each singular KPI K1 and each singular KPI K2 such that K1 is directly below K2, add a link from node(K1) to node(K2);
For each singular KPI K1 and each non-singular KPI K2 such that K1 is directly below K2, add a link from node(K1) to node(Eqv(K2)); and
For each non-singular KPI K1 and each singular KPI K2 such that K1 is directly below K2, add a link from node(Eqv(K1)) to node(K2).

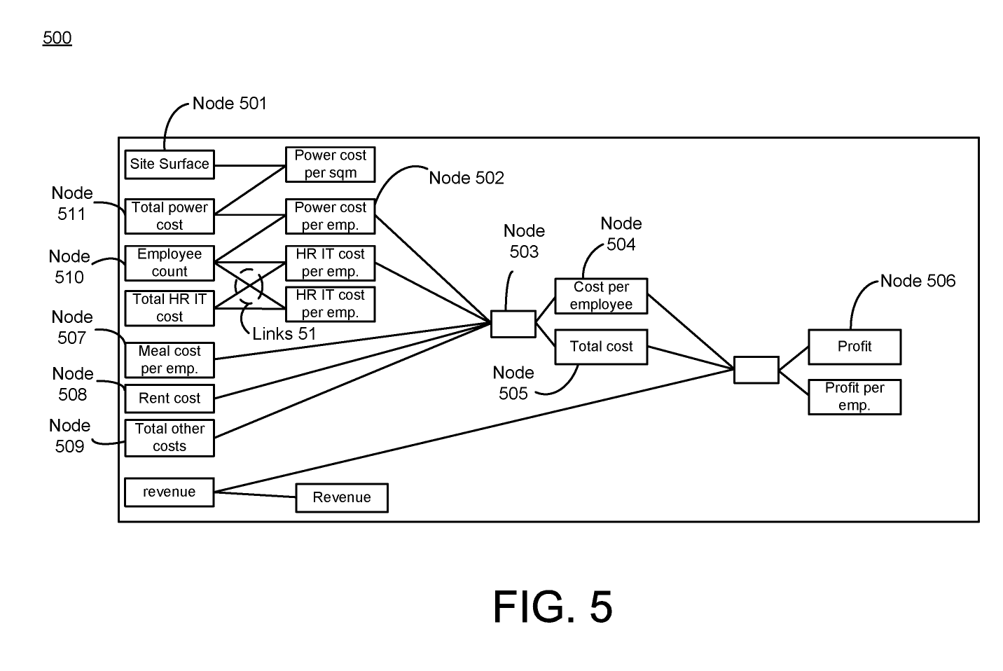

KPI node-link diagram 500, which is shown in FIG. 5, may be generated by rendering engine 144 using the foregoing example algorithms for Generation of Nodes and Generation of Links. However, unlike the driver-KPI concept nodes of FIG. 4, which represent driver-KPI concepts, the nodes in KPI node-link diagram 500 may, for example, represent single drivers or single KPIs (to the extent possible). In FIG. 5, nodes (e.g., node 501, node 502, etc.) of the directed acyclic graph (which are depicted, for example, as rectangles) may represent individual KPIs or individual drivers or may be a generic connector node (e.g., node 503).

KPI node-link diagram 500, as shown in FIG. 5, may, for example, visually convey the following information on the Equivalence of KPIs, and the Dependencies of KPIs, to a viewer.

### Equivalence of KPIs:

For example, KPIs “cost per employee” (node 504) and KPI “total cost” (node 505) depend on exactly the same drivers (as they as share a downstream generic node—node 503). Similarly, drivers “meal cost per employee” (node 507), “rent cost” (node 508) and “total other cost” (node 509) influence exactly the same KPIs (as they as share an upstream generic node—node 503).
   Dependencies between KPIs:
For example, the KPI “power cost per employee” (on node 502) depends on fewer drivers (e.g., total power cost and employee count on nodes 510 and 511, respectively) than the KPI “total cost” (node 505), which in turn depends on fewer drivers than the KPI “profit” (on node 506).

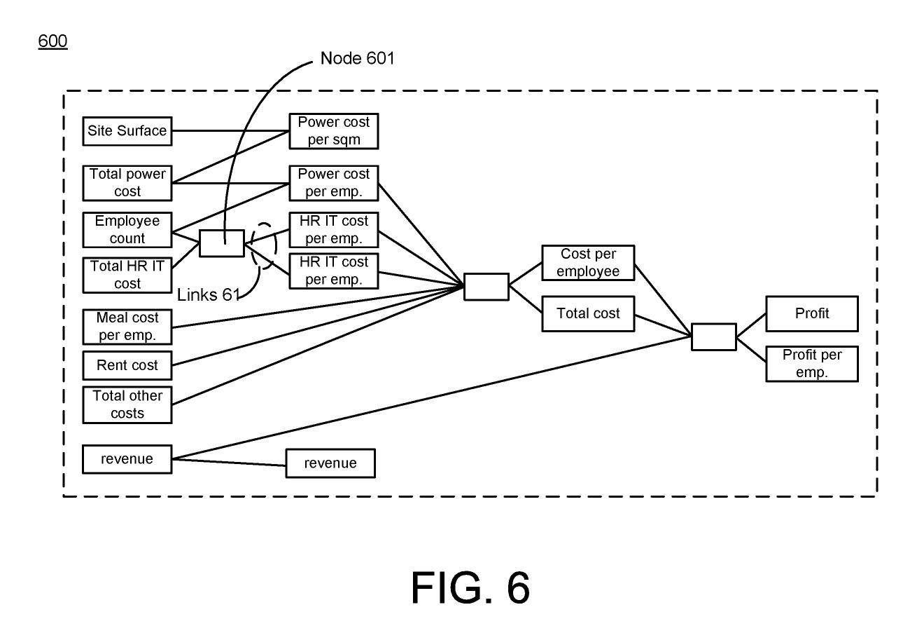

With reference to FIG. 6, rendering engine 144 may generate KPI node-link diagram 600 (like KPI node-link diagram 400 FIG. 4, and KPI node-link diagram 500 FIG. 5) by establishing the concept hierarchy for KPI-driver matrix 200 and using notions of so-called object-concepts and attribute-concepts to order and link the nodes in KPI node-link diagram 600. Rendering engine 144 may generate a link between two concepts C1 and C2 if and only if C1 is below C2 and there is no other concept between C1 and C2. Like the nodes of FIG. 5, the nodes in KPI node-link diagram 600 may, for example, represent single drivers or single KPIs (to the extent possible). Unlike KPI node-link diagram 500, KPI node-link diagram 500 may include a node(E) for each equivalence class E containing more than one element even when the equivalence class E is minimal.

Rendering engine 144 may use the following example algorithms for generating the single driver or single KPI nodes and generating the links that are shown in KPI node-link diagram 600.

Generation of Nodes:
For each driver D, generate a fresh node—node(D);
For each KPI K generate a fresh node—node(K); and
For each equivalence class E containing more than one element, generate a fresh node—node(E).

Generation of links:
For each driver D and each singular KPI K such that (Kpi(D), Drv(Kpi(D))) is directly below (Kpi(Drv(K)), Drv(K)), add a link from node(D) to node(K);
For each driver D and each non-singular KPI K such that (Kpi(D), Drv(Kpi(D))) is directly below (Kpi(Drv(K)), Drv(K)), add a link from node(D) to node(Eqv(K));
For each singular KPI K1 and each singular KPI K2 such that K1 is directly below K2, add a link from node(K1) to node(K2);
For each singular KPI K1 and each non-singular KPI K2 such that K1 is directly below K2, add a link from node(K1) to node(Eqv(K2)); and
For each non-singular KPI K1 and each singular KPI K2 such that K1 is directly below K2, add a link from node(Eqv(K1)) to node(K2).

Creating a node(E) for each equivalence class E containing more than one element even when the equivalence class E is minimal may create a generic node (e.g., node 601), which gathers up otherwise crisscrossing links 61 and makes for visualizations that are easier on the viewer's eye (compare, for example, crisscrossing links 51 FIG. 5).

As noted earlier, rendering engine 144 may present a KPI node-link diagram (e.g., KPI node-link diagram 148, 400, 500 or 600) as an interactive display on UI 142. Rendering engine 144 may include user-activable UI control elements (e.g., links, filters, area selectors, etc.) in the visual display of the KPI node-link diagram on UI 142. The user-activable UI control elements (“visual UI elements”) may be integrated in the KPI node-link-diagram displayed on UI 142. For example, each node (e.g., node 401, 501, 610, etc.) in the KPI node-link-diagram displayed on UI 142 maybe represented by a point-and-click or a hover-over control UI element amenable to user selection (for drill down).

The visual UI elements may be configured so that a user can interact with the displayed KPI node-link-diagram to focus on, explore, investigate, monitor, or study individual KPIs at different levels of the concept hierarchy displayed of the computer screen. When the viewer activates a visual UI element (e.g., by clicking on, pointing to or hovering over the visual UI element) rendering engine 144 may display information related to the corresponding node, branch, or hierarchy level. The displayed information may, in addition to the identification of the nodes (e.g., names of drivers and KPIs), include actual numerical values of drivers and KPIs. For KPI-nodes, the displayed information may include status information (e.g., KPI is above or below a threshold, etc.).

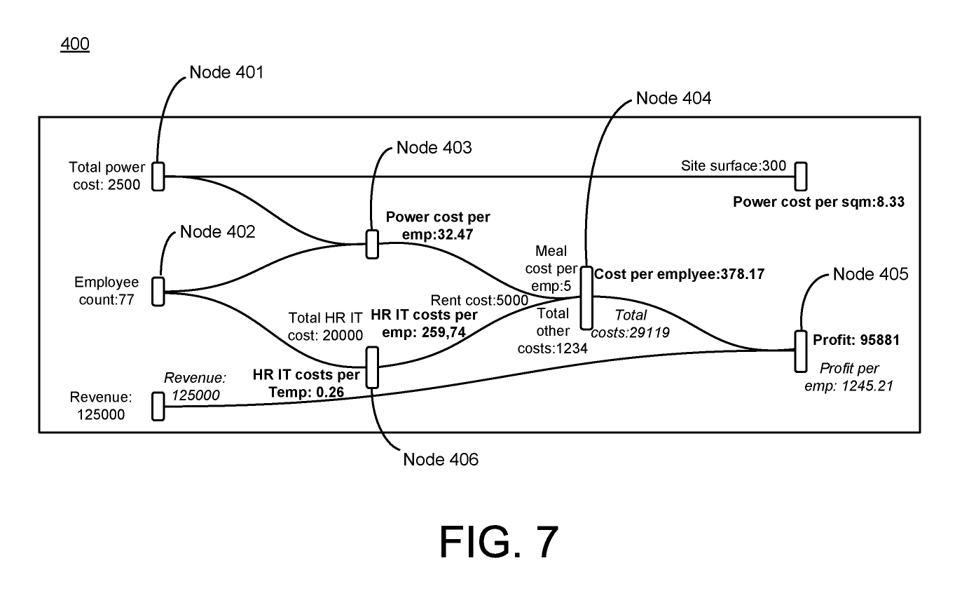

FIG. 7 shows, for example, a KPI node-link diagram (e.g., KPI node-link diagram 400 of FIG. 4) in which rendering engine 144 displays numerical values for the displayed drivers and KPIs (e.g., for node 406: driver “total HR IT cost 20000” and KPIs “HR IT cost per employee 259.74” and “”HR IT cost per Temp. 0.26″). FIG. 7 also shows, for example, that rendering engine 144 may include status information (e.g., a KPI is above or below a threshold, etc.) in the KPI node-link diagram by using a suitable color scheme or marking scheme to indicate the status of a KPI. In an example color scheme, red colored font may be used to indicate that a KPI is below the corresponding threshold or in a critical state and green colored font may be used to indicate that the KPI is above the corresponding threshold and in an uncritical state. In the black and white drawing shown in FIG. 4, names of the KPIs (e.g. KPI “total cost” (node 404) that are above the corresponding threshold are shown in regular font text, and names of the KPIs (e.g. KPI “cost per employee” (node 404)) that are below the corresponding threshold are shown in bolded font.

In further example implementations, rendering engine may, for example, be configured to highlight the nodes below or above the node associated with an activated hover-over UI element (e.g., activated when a user hovers over the hover-over element) to visually demonstrate a chain of KPI-driver dependencies across multiple hierarchy levels.

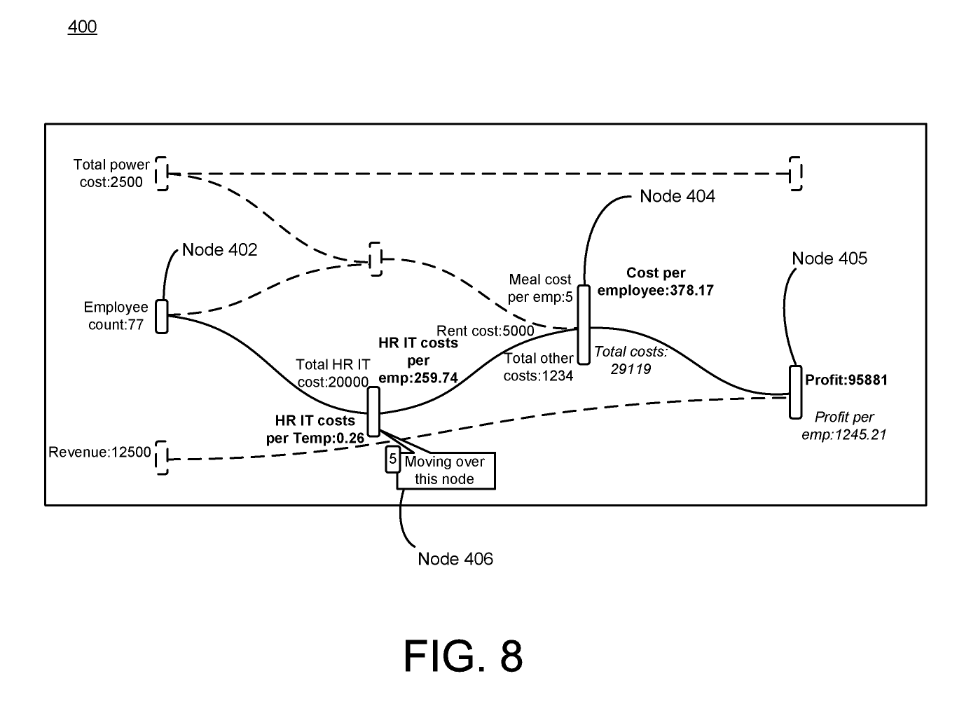

FIG. 8 shows, for example, a KPI node-link diagram (e.g., KPI node-link diagram 400 of FIG. 4) in which rendering engine 144 highlights nodes below (e.g., node 402) and nodes above (e.g., nodes 404 and 405) a node (e.g., node 406), which may have been user-activated by hovering over the hover-over element corresponding to node 406.

The visual UI elements provided on UI 142 may include a data-entry UI element (e.g., a text entry box) allowing users to edit or change a numerical value of a driver and/or a KPI displayed in the KPI node-link diagram. Rendering engine 144 may be configured, in response to any editing or changing of the value of the driver and/or the KPI, to dynamically adjust or change the values and states of the other drivers and KPIs in the displayed KPI node-link diagram.

It will be understood that rendering engine 144 may dynamically update the KPI node-link diagram (e.g., KPI node-link diagram 148, 400, 500 or 600) shown as an interactive display on UI 142 in real time or near real time so that any information (e.g., driver and KPI values) conveyed by the visual representation of the KPI node-link diagram is timely and relevant to the viewer.

Additional or detailed information on the nodes or portions or fragments (e.g., nodes or group of nodes) of the KPI node-link diagram (e.g., KPI node-link diagram 148, 400, 500 or 600), which are selected for drill down, may be displayed by rendering engine 144 as views (e.g., in pop-up windows or display panels) other than, and in addition to, the KPI node-link diagram displayed in UI 142.

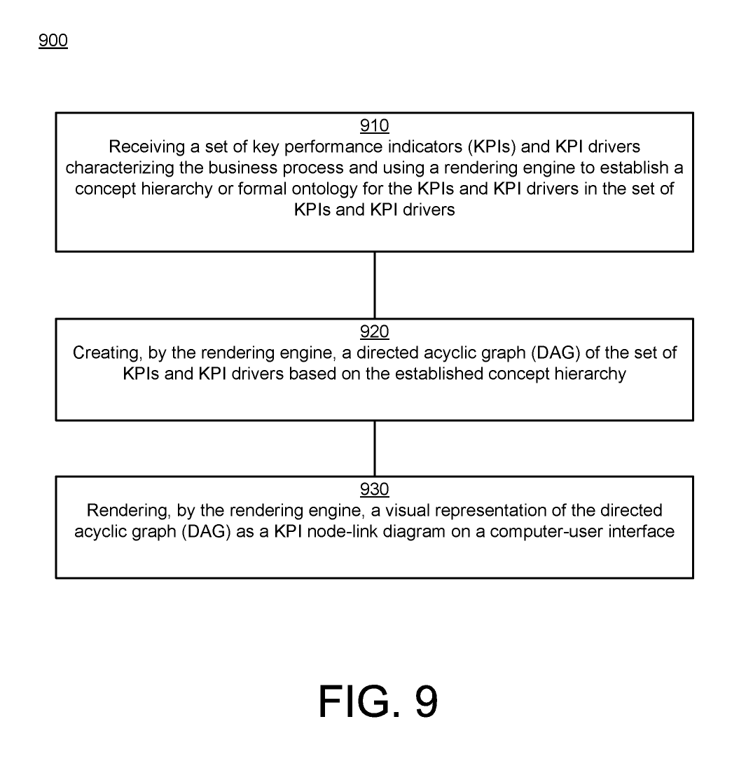

FIG. 9 shows an example method 900 using a rendering engine to visualize a set of KPIs and KPI drivers on a computer-user interface, in accordance with the principles of the present disclosure.

The subject set of KPIs and KPI drivers may, for example, relate to or characterize a business process of a business, organization, or industry. The set of KPIs and KPI drivers of the business process may, for example, be monitored or evaluated by a business application, which may be hosted on one or more computers. The KPIs and KPI drivers may be interrelated, for example, by including a single KPI driver that influences more than one KPI and/or, conversely, by including a single KPI that depends on more than KPI driver. A KPI-driver dependency matrix may tabulate the interdependencies of the various KPIs and KPI drivers in the set.

Method 900 may include receiving a set of key performance indicators (KPIs) and KPI drivers characterizing the business process and using a rendering engine to establish a concept hierarchy or formal ontology for the KPIs and KPI drivers in the set of KPIs and KPI drivers (910). Each concept in the hierarchy may represent a set of KPI-driver matrix objects sharing the same values for a certain set of properties; and each sub-concept in the hierarchy may contain a subset of the objects in the concepts above it in the hierarchy. Method 900 may involve creating, by the rendering engine, a directed acyclic graph (DAG) of the set of KPIs and KPI drivers based on the established concept hierarchy (920). Method 900 may further include rendering, by the rendering engine, a visual representation of the directed acyclic graph (DAG) as a KPI node-link diagram on a computer-user interface (930). Method 900 may involve formatting the KPI node-link diagram presented on the computer-user interface as a right-headed drawing i.e. a visualization designed to be read from left to right.

The KPI node-link-diagram may be presented as an interactive graphical representation of business process, which may be dynamic, on the computer user interface.

In method 900, using the rendering engine to render a visual representation of the directed acyclic graph (DAG) as a KPI node-link diagram on the computer-user interface 930 may involve generating a link between two concepts C1 and C2 if and only if C1 is below C2 and there is no other concept between C1 and C2.

In an example implementation, using the rendering engine to render a visual representation of the directed acyclic graph (DAG) as a KPI node-link diagram on the computer-user interface 930 may involve generating driver-KPI concept nodes and generating links between the driver-KPI concept nodes.

Generating driver-KPI concept nodes may involve for each driver D, generating the driver-KPI-concept node(D):=(Kpi(D), Drv(Kpi(D))); and, for each KPI K, generating the driver-KPI-concept node(K):=(Kpi(Drv(K)), Drv(K)).

Generating links between the driver-KPI concept nodes may involve: for each driver D and each KPI K where D influences K, adding a link from node(D) to node(K); for each KPI K1 and each singular KPI K2 such that K1<K2 and when there is no K with K1<K<K2, adding a link from node(K1) to node(K2); and for each KPI K1 and each non-singular KPI K2 such that K1<K2 and there is no K with K1<K<K2, adding a link from node(K1) to node(Eqv(K2)).

Using the rendering engine to render a visual representation of the directed acyclic graph (DAG) as a KPI node-link diagram on the computer-user interface 930 may involve adding labels to the display to show the KPIs and drivers associated with each the driver-KPI concept node in the display.

In another example implementation, using the rendering engine to render a visual representation of the directed acyclic graph (DAG) as a KPI node-link diagram on the computer-user interface 930 may involve generating nodes, which represent single drivers or single KPIs, and generating links between the nodes.

Generating nodes, which represent single drivers or single KPIs, may involve: for each driver D, generating a fresh node—node(D); for each KPI K, generating a fresh node—node(K); and, for each equivalence class E containing more than one element and which is not minimal, generating a fresh node—node(E). In a version of the implementation, generating nodes, which represent single drivers or single KPIs, may involve, generating a fresh node—node(E), for each equivalence class E containing more than one element even when the equivalence class E is minimal.

Generating of links between the nodes, which represent single drivers or single KPIs, may include: for each driver D and each KPI K where D influences K, adding a link from node(D) to node(K); for each KPI K1 and each singular KPI K2 such that K1<K2 and there is no K with K1<K<K2, adding a link from node(K1) to node(K2); and for each KPI K1 and each non-singular KPI K2 such that K1<K2 and there is no K with K1<K<K2, adding a link from node(K1) to node(Eqv(K2)).

Method 900 may also involve providing user-activable UI control elements (e.g., a sliding window filter UI element, a point-and-click UI element, a hover-over UI control element, etc.) with KPI node-link diagram on the computer-user interface. The user-activable UI control elements may be configured to enable a viewer to select fragments or portions (e.g., a node or group of nodes, hierarchy levels, etc.), for example, for drill down investigations of the KPI node-link-diagram.

Method 900 may involve, in response to user activation of a UI control element to select a fragment or portion (e.g., a node or group of nodes, hierarchy levels, etc.) of the KPI node-link-diagram, displaying additional information (e.g., names, numerical values, status, etc.) associated with the selected fragment or portion.

In an example implementation, method 900 may involve integrating the user-activable UI control elements in the KPI node-link-diagram displayed on UI 142. For example, each node in the KPI node-link-diagram displayed on UI 142 maybe represented by a point-and-click or a hover-over control UI element amenable to user selection (for drill down).

When the viewer activates a UI control element (e.g., by clicking on, pointing to or hovering over the UI control element), method 900 may involve having the rendering engine display information related to the corresponding node, branch, or hierarchy level. The displayed information may, in addition to the identification of the nodes (e.g., names of drivers and KPIs), include actual numerical values of drivers and KPIs. For KPI-nodes, the displayed information may include status information (e.g., KPI is above or below a threshold, etc.).

Additionally or alternatively, method 900 may involve having the rendering engine highlight the nodes below or above the node associated with an activated hover-over UI element (e.g., activated when a user hovers over the hover-over element) to visually demonstrate a chain of driver-KPI dependencies across several levels of the node hierarchy.

Method 900 may involve providing a data-entry UI element (e.g., a text entry box) allowing users to edit or change a numerical value of a driver and/or a KPI in the displayed KPI node-link diagram. Rendering engine 144 may be configured, in response to any editing or changing of the value of the driver and/or the KPI, to dynamically adjust or change the values and states of the other drivers and KPIs in the displayed KPI node-link diagram.

The various systems and techniques described herein may be implemented in digital electronic circuitry, or in computer hardware, firmware, or in combinations of them. The various techniques may implemented via a computer program product, i.e., a computer program with instructions tangibly embodied in a machine readable storage device, for execution by, or to control the operation of, data processing apparatus, e.g., a programmable processor, a computer, or multiple computers.

Method steps may be performed by one or more programmable processors executing a computer program to perform functions by operating on input data and generating output. Method steps also may be performed by, and an apparatus may be implemented as, logic circuitry or special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method comprising:
receiving, by a rendering engine, a set of key performance indicators (KPIs) and KPI drivers characterizing a business process;
using the rendering engine to establish a concept hierarchy for the KPIs and KPI drivers in the set of KPIs and KPI drivers, each concept in the concept hierarchy representing a set of KPI-driver matrix objects sharing one or more same attributes for a certain set of properties and each sub-concept in the concept hierarchy containing a subset of the objects in the concepts above the sub-concept in the concept hierarchy;
creating, by the rendering engine, a directed acyclic graph (DAG) of the set of KPIs and KPI drivers based on the established concept hierarchy; and
rendering, by the rendering engine, a visual representation of the directed acyclic graph (DAG) as a KPI node-link diagram on a computer-user interface.

2. The method of claim 1 wherein rendering, by the rendering engine, a visual representation of the directed acyclic graph (DAG) as a KPI node-link diagram on a computer-user interface includes formatting the KPI node-link diagram presented on the computer-user interface as a right-headed drawing designed to be read from left to right.

3. The method of claim 1 wherein rendering, by the rendering engine, a visual representation of the directed acyclic graph (DAG) as a KPI node-link diagram on a computer-user interface includes generating a link between a first concept and a second concept if and only if the first concept is below the second concept and there is no other concept between the first concept and the second concept.

4. The method of claim 1 wherein rendering, by the rendering engine, a visual representation of the directed acyclic graph (DAG) as a KPI node-link diagram on a computer-user interface includes generating driver-KPI concept nodes and generating links between the driver-KPI concept nodes.

5. The method of claim 4 wherein generating driver-KPI concept nodes includes adding labels to the visual representation of the KPI node-link diagram on the computer-user interface to identify the KPIs and drivers associated with each driver-KPI concept node in the KPI node-link diagram.

6. The method of claim 1 wherein rendering, by the rendering engine, a visual representation of the directed acyclic graph (DAG) as a KPI node-link diagram on a computer-user interface includes generating nodes, which represent single drivers or single KPIs, and generating links between the nodes.

7. The method of claim 6, wherein generating nodes, which represent single drivers or single KPIs, includes:
for each driver D, generating a fresh node—node(D);
for each KPI K, generating a fresh node—node(K); and,
for each equivalence class E containing more than one element and which is not minimal, generating a fresh node—node(E).

8. The method of claim 7, wherein generating nodes, which represent single drivers or single KPIs, further includes generating a fresh node—node(E), for each equivalence class E containing more than one element even when the equivalence class E is minimal.

9. The method of claim 1 further comprising providing user-activable UI control elements with KPI node-link diagram on the computer-user interface.

10. The method of claim 9 further comprising displaying, by the rendering engine, one or more of KPI and driver names, KPI and driver numerical values, KPI status and a chain of driver-KPI dependencies associated with a node in response to user activation of a UI control element corresponding to the node.

11. A computer system comprising:
a memory;
a semiconductor-based processor; and
a rendering engine configured to:
receive a set of key performance indicators (KPIs) and KPI drivers characterizing a business process;
establish a concept hierarchy for the KPIs and KPI drivers in the set of KPIs and KPI drivers, each concept in the concept hierarchy representing a set of KPI-driver matrix objects sharing one or more same attributes for a certain set of properties and each sub-concept in the concept hierarchy containing a subset of the objects in the concepts above the sub-concept in the concept hierarchy;
create a directed acyclic graph (DAG) of the set of KPIs and KPI drivers based on the established concept hierarchy; and
render a visual representation of the directed acyclic graph (DAG) as a KPI node-link diagram on a computer-user interface.

12. The computer system of claim 11, wherein the rendering engine is configured present the KPI node-link diagram on the computer-user interface as a right-headed drawing designed to be read from left to right.

13. The computer system of claim 11, wherein the rendering engine is configured to generate a link between a first concept and a second concept if and only if the first concept is below the second concept and there is no other concept between the first concept and the second concept.

14. The computer system of claim 11, wherein the rendering engine is configured to generate driver-KPI concept nodes and generate links between the driver-KPI concept nodes in the KPI node-link diagram.

15. The computer system of claim 14, wherein the rendering engine is configured to add labels to the visual representation of the KPI node-link diagram on the computer-user interface to identify the KPIs and drivers associated with each driver-KPI concept node in the KPI node-link diagram.

16. The computer system of claim 11, wherein the rendering engine is configured to generate nodes, which represent single drivers or single KPIs, and generate links between these nodes in the KPI node-link diagram.

17. The computer system of claim 16, wherein the rendering engine is configured to generate nodes, which represent single drivers or single KPIs, by:
for each driver D, generating a fresh node—node(D);
for each KPI K, generating a fresh node—node(K); and,
for each equivalence class E containing more than one element and which is not minimal, generating a fresh node—node(E).

18. The computer system of claim 17, wherein the rendering engine is further configured to generate nodes, which represent single drivers or single KPIs, by:
additionally generating a fresh node—node(E), for each equivalence class E containing more than one element when the equivalence class E is minimal.

19. The computer system of claim 11, wherein the rendering engine is configured to integrate user-activable UI control elements with KPI node-link diagram on the computer-user interface.

20. The computer system of claim 19, wherein the rendering engine is configured to display one or more of KPI and driver names, KPI and driver numerical values, KPI status and a chain of driver-KPI dependencies associated with a node in response to user activation of a UI control element corresponding to the node.
